(19) United States
(12) Patent Application Publication
(10) Pub. No.: US 2025/0078843 A1
(43) Pub. Date: Mar. 6, 2025

(54) METHOD FOR DESIGNING INTERFERENCE NOISE OF SPEECH BASED ON THE HUMAN SPEECH STRUCTURE

(71) Applicant: ZJU-HANGZHOU GLOBAL SCIENTIFIC AND TECHNOLOGICAL INNOVATION CENTER, HANGZHOU, Zhejiang Province (CN)

(72) Inventors: ZHONGJIE BA, HANGZHOU, ZHEJIANG PROVINCE (CN); PENG HUANG, HANGZHOU, ZHEJIANG PROVINCE (CN); YAO WEI, HANGZHOU, ZHEJIANG PROVINCE (CN); PENG CHENG, HANGZHOU, ZHEJIANG PROVINCE (CN); LI LU, HANGZHOU, ZHEJIANG PROVINCE (CN); FENG LIN, HANGZHOU, ZHEJIANG PROVINCE (CN); ZHENGUANG LIU, HANGZHOU, ZHEJIANG PROVINCE (CN); KUI REN, HANGZHOU, ZHEJIANG PROVINCE (CN)

(21) Appl. No.: 18/285,079

(22) PCT Filed: Dec. 21, 2022
(86) PCT No.: PCT/CN2022/140663

§ 371 Date: Sep. 29, 2023

(30) Foreign Application Priority Data
Nov. 15, 2022 (CN) 202211427811.0

(51) Int. Cl. G10L 17/14; G10L 21/0272

(52) U.S. Cl. CPC G10L 17/14; G10L 21/0272

(57) ABSTRACT

The present invention discloses a method for designing an interference noise of speech based on the human speech structure, including the following steps: (1): obtaining a large amount of speech data containing different speakers and different speech contents, extracting voiceprint information, and then building an initial speech data set; (2): for each user, obtaining a small amount of speech data of the user, extracting voiceprint information, and then matching the most similar speech data in the initial speech data set; (3): performing data augmentation on the matched speech data; (4): segmenting the augmented speech data with a phoneme segmentation algorithm to form a vowel data set and a consonant data set; (5): constructing three noise sequences based on the vowel data set and the consonant data set, and performing superimposition to obtain an interference noise; and (6): continuously generating and playing randomly generated interference noise, and continuously injecting the interference noise into recordings to implement continuous interference. With the present invention, the interference noise cannot be removed from the speech, thereby avoiding the leakage of user privacy information.

### TECHNICAL FIELD

The present invention belongs to the field of speech privacy protection, and particularly relates to a method for designing an interference noise of speech based on the human speech structure.

### BACKGROUND TECHNOLOGY

With the development of science and technology, mobile phones, smart televisions, smart speakers, and other devices with recording capabilities are becoming more and more common in our lives. Due to the black box nature of smart devices, users cannot be fully aware of the content of the program running inside the devices, which poses a great threat to the privacies of the users. Attackers can eavesdrop on the speech of the users in the environment by controlling the devices, and then recognize the content of the speech by using rapidly developing speech recognition systems based on deep learning, so as to steal the privacies of the users.

Therefore, how to effectively prevent eavesdropping has become a hot research direction. Existing anti-eavesdropping products such as Project Alias and Paranoid Home Wave can prevent microphones from recording by injecting white noise into them, but they need to know specific locations of the microphones and configure a noise emitter for each microphone, which greatly limits the usage scenarios of these products. Moreover, the researchers have found that using white noise to interfere with recordings is not a reliable solution. Some existing denoising methods such as a deep learning-based speech denoising algorithm proposed by Xiang Hao et al. in “FullSubNet: A Full-Band and Sub-Band Fusion Model for Real-Time Single-Channel Speech Enhancement” can effectively remove white noise interference in audios, which means that using the white noise to interfere with the recordings cannot effectively prevent the leakage of speech privacies.

In recent years, researchers have proposed a solution for interference with a recording based on ultrasonic waves, whose basic principle is to inject noise based on the nonlinearity of microphones in devices, so as to interfere with the eavesdropping devices without interfering with users in the environment. Yuxin Chen et al. designed a wearable bracelet in “Wearable Microphone Jamming”. The bracelet is equipped with multiple ultrasonic transmitters that can continuously transmit ultrasonic waves to interfere with recording devices in the environment. Lingkun Li et al. designed an ultrasonic transmitting device in “Patronus: Preventing Unauthorized Speech Recordings with Support for Selective Unscrambling”, which can transmit variable frequency noise based on a pre-generated key, thus allowing authorized recording devices to record while interfering with unauthorized recording devices.

Although the above multiple interference methods can effectively inject the noise into the eavesdropping devices, the noise used therein is too simple, such as the white noise and the variable frequency noise. Some existing denoising algorithms, such as deep learning-based FullSubNet, noise characteristic-based spectral subtraction, and filtering, can remove noises from a speech, such that a method for interference with a recording at present cannot effectively prevent attackers from stealing privacy information of users from noisy recordings, and thus cannot meet current security requirements.

### SUMMARY OF THE INVENTION

In view of the shortcomings in existing interference solutions for speech eavesdropping, the present invention provides a method for designing an interference noise of speech based on the human speech structure. The generated interference noise can efficiently interfere with the speech at low energy and maintain strong robustness, making the disturbed speech unable to be recognized by the human auditory system or machine-based speech recognition systems; and existing algorithms of speech enhancement and noise removal cannot effectively remove the interference noise from the original speech, thereby avoiding the leakage of user privacy information.

A method for designing an interference noise of speech based on the human speech structure includes the following steps:
(1): obtaining a large amount of speech data containing different speakers and different speech contents, extracting voiceprint information of each of the speakers in the speech data, and building an initial speech data set;
(2): for each user, obtaining a small amount of speech data of the user, extracting voiceprint information of the speech data of the user, and based on the extracted voiceprint information of the user, matching the most similar speech data in the initial speech data set generated in the step (1) with a voiceprint information matching algorithm;
(3): performing data augmentation on the matched speech data in the step (2);
(4): performing phoneme-level segmentation on the augmented speech data by using a phoneme segmentation algorithm to form a vowel data set and a consonant data set;
(5): constructing three noise sequences based on the vowel data set and the consonant data set, and superimposing the three noise sequences to obtain an interference noise, where two noise sequences are of splicing vowel data, and one noise sequence is of splicing consonant data; and
(6): continuously generating and playing a randomly generated interference noise, and continuously injecting the interference noise into recordings to achieve continuous interference, thereby preventing privacy information in the recording from being stolen.

Preferably, in the steps (1) and (2), the voiceprint information is extracted with a neural network, an input of the neural network is a continuous time domain speech signal, and an output thereof is a vector representing the voiceprint information; where the neural network is represented by e=ƒ(x), x being a speech signal with a length of greater than 1.6 s, e being output voiceprint information, a dimension being 1×256.

Preferably, in the step (2), the voiceprint information matching algorithm is a cosine distance-based matching algorithm, specifically,
if it is assumed that the voiceprint information of a current user is eₜ and the voiceprint information of each of the speakers in the initial speech data set is eᵢ in which i∈[1, N] and N is the number of speakers in the initial speech data set, a matched most similar speaker j in the data set needs to satisfy the following expression:

$$d ( {e}_{t} , {e}_{j} ) \leq d ( {e}_{t} , {e}_{i} ) , ∀ i ∈ [ 1 , N ]$$

where d(x,y) is a cosine distance between two vectors,

$$d ( x , y ) = \frac{x \cdot y}{‖ x ‖ ‖ y ‖} .$$

Preferably, in the step (2), a length of the obtained speech data of the user is 8-15 seconds, to accurately extract the voiceprint information of the user.

Preferably, in the step (3), the data augmentation with an augmentation algorithm based on speech emotional characteristics includes five augmentation modes of speech speed modification, average fundamental frequency modification, fundamental frequency curve modification, energy modification, and time order modification.

During the speech speed modification, a speech speed modification parameter is randomly sampled from a uniform distribution U(0.3, 1.8), and when the speech speed modification parameter is greater than 1, acceleration is indicated, or when the speech speed modification parameter is less than 1, deceleration is indicated.

During the average fundamental frequency modification, an average fundamental frequency modification parameter is randomly sampled from a uniform distribution U(0.9, 1.1), and when the average fundamental frequency modification parameter is greater than 1, a fundamental frequency is increased, or when the average fundamental frequency modification parameter is less than 1, a fundamental frequency is reduced.

During the fundamental frequency curve modification, a fundamental frequency curve modification parameter is randomly sampled from a uniform distribution U(0.7, 1.3), and when the fundamental frequency curve modification parameter is greater than 1, an original fundamental frequency curve is stretched, or when the fundamental frequency curve modification parameter is less than 1, the original fundamental frequency curve is compressed.

During the energy modification, an energy modification parameter is randomly sampled from a uniform distribution U(0.5, 2), and an original audio signal s(t) is multiplied by the energy modification parameter.

During the time order modification, a speech is directly inverted in a time domain.

Preferably, in the step (4), the phoneme segmentation algorithm is a Prosodylab-Aligner-based alignment algorithm, and a specific segmentation process includes:
firstly training a speaker-independent acoustic model based on a Gaussian mixture model with an open-source data set such as aidatatang_200zh; on the basis of the model, performing fine adjustment on the model based on data of each of the speakers in the initial speech data set built in the step (1), and eventually generating a special acoustic model for each speaker; during the segmentation, firstly selecting an acoustic model for a corresponding speaker, inputting an audio and a corresponding text, and outputting, by the model, types of phonemes in the audio and corresponding timestamps in sequence; and segmenting each of the phonemes in the audio based on the timestamps, and classifying the phonemes into vowels and consonants according to the types of the phonemaes, so as to form the vowel data set and the consonant data set.

The step (5) specifically includes:
randomly selecting vowels from the vowel data set, splicing the vowels, performing smoothing on splicing positions by using a Hamming window with a length of 25 ms, and accelerating an obtained sequence to 1.1 times an original sequence, to obtain a first noise signal;
then, randomly selecting vowels from the vowel data set, modifying a speed of each of the vowels to α times that of an original vowel, a being a random number randomly sampled from a uniform distribution U(0.3, 1.8), resampling each vowel, splicing the vowels with modified speeds, and inserting a blank space, with a length randomly sampled from a uniform distribution U(0.001, 0.1), between the vowels, to obtain a second noise signal;
next, randomly selecting consonants from the consonant data set, splicing the consonants, and performing smoothing on splicing positions by using the Hamming window with the length of 25 ms, to obtain a third noise signal; and
finally, directly superimposing the three noise signals, to obtain the final interference noise.

Compared with the prior art, the present invention has the following beneficial effects:
1. Compared with the existing speech interference noises (such as a white noise), the interference noise designed in the present invention can achieve a stronger interference effect at the same energy.
2. Compared with the existing speech interference noises, the noise designed in the present invention has stronger robustness and is more difficult to be removed by existing denoising algorithms.
3. Compared with the existing aimless speech interference noises, the noise designed in the present invention is generated for each user, thereby having stronger pertinence and a better interference effect.
4. Based on the diversity of corpora and the speech data augmentation algorithm proposed in the present invention, the interference noise designed in the present invention has a low repetition rate, better diversity, and wider interference universality.

### BRIEF DESCRIPTION OF THE DRAWINGS

FIG. 1 is an overall flowchart of a method for designing an interference noise of speech based on the human speech structure according to an embodiment of the present invention;

FIG. 2 is a design block diagram of generating an interference noise by a vowel data set and a consonant data set in an embodiment of the present invention;

FIG. 3 shows word error rates of a speech containing a disturbance noise in different speech recognition models; and

FIG. 4 shows word error rates of a speech containing a disturbance noise, in different speech recognition models, before and after being processed by a speech denoising algorithm.

### DETAILED DESCRIPTION OF THE EMBODIMENTS

The present invention will be further described in detail below with reference to the accompanying drawings and the embodiments. It should be pointed out that the following embodiments are intended to facilitate the understanding of the present invention, but do not have any limitation on it.

At present, the issue of speech privacy leakage has received widespread attention. Attackers can get recordings and steal speech privacy information of targets by controlling widely distributed intelligent devices. Existing speech interference noises have the drawbacks of poor interference effects, low robustness, and the like, and cannot well protect user privacies.

Based on this, the present invention provides a method for designing an interference noise of speech based on the human speech structure. The designed speech interference noise can be implemented in an actual scenario, making it difficult for an attacker to extract privacy information of a target from the disturbed speech. Moreover, the noise has strong robustness, making it difficult for the attacker to remove the interference noise from the recording by using existing denoising algorithms.

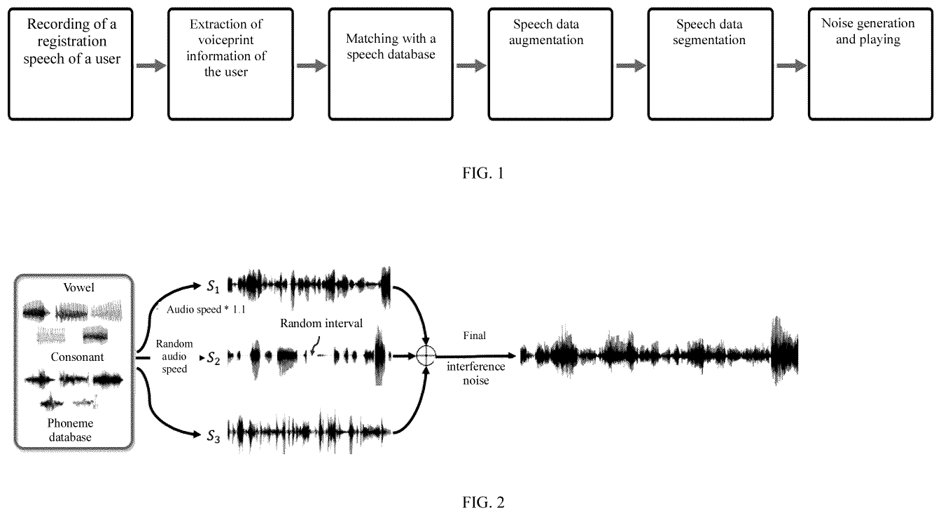

As shown in FIG. 1, a method for designing an interference noise of speech based on the human speech structure includes the following steps.

In step S1, a speech data set is built.

Contents of the speech data set should be as rich as possible and can widely cover speakers of different ages, genders, accents, and emotions, and speech contents should be as rich as possible. Public data sets such as LibriSpeech and GigaSpeech can be used. Moreover, voiceprint information of each speaker in the obtained speech data set is calculated based on a deep learning method.

In step S2, a user makes registration.

10 seconds speech data of the user is recorded with a device such as a mobile phone, and voiceprint information of the user is extracted with the same method as that in the step S1 based on the data.

In step S3, the most similar speech data is obtained.

The speech data with the most similar voiceprint to the speaker is obtained from the built speech data set. The similarity is defined as a cosine distance between the voiceprint information. The large the cosine distance is, the lower the similarity is, otherwise, the higher the similarity is.

A cosine distance-based matching algorithm is specifically as follows: if it is assumed that the voiceprint information of a current user is eₜ and the voiceprint information of each speaker in a database is eᵢ in which i∈[1, N] and N is the number of speakers in the speech data set, a matched most similar speaker j in the database needs to satisfy the following expression: d(eₜ, eⱼ)≤d(eₜ, eᵢ), ∀i∈[1, N], where d(x, y) is a cosine distance between two vectors,

$$d ( x , y ) = \frac{x \cdot y}{‖ x ‖ ‖ y ‖} .$$

In step S4, speech augmentation is performed.

The matched speech data is subjected to augmentation based on speech emotional characteristics. The augmentation includes five augmentation modes of speech speed modification, average fundamental frequency modification, fundamental frequency curve modification, energy modification, and time order modification. If it is assumed that an original audio signal is s(t), a specific augmentation algorithm is as follows:
a speech speed modification parameter α is randomly sampled from a uniform distribution U(0.3, 1.8), and when the speech speed modification parameter is greater than 1, acceleration is indicated, or when the speech speed modification parameter is less than 1, deceleration is indicated. The speech speed modification includes two optional modes. In a first mode, a speech speed can be directly modified with a ffmpeg tool kit. An obtained speech is s₁(t)=ƒƒmpeg.a_speed(s(t), α). This mode has the advantage of a good conversion effect and the shortcoming of low efficiency. In a second mode, which is based on a method of a phase vocoder, the speech is converted into a frequency domain signal, then a frequency spectrum is interpolated frame by frame in a frequency domain, and finally the frequency spectrum is converted back to a time domain. An obtained speech is s₁(t)=PhaseVocoder(s(t), α). The second mode has the advantage of a high conversion speed and the shortcoming of a poor conversion effect.

A fundamental frequency modification parameter α is randomly sampled from a uniform distribution U(0.9, 1.1), and when the fundamental frequency modification parameter is greater than 1, a fundamental frequency is increased, or when the fundamental frequency modification parameter is less than 1, a fundamental frequency is reduced. To modify the fundamental frequency, firstly the speech speed is modified to 1/α times an original speech speed by using the above speech speed modification mode to obtain s₁(t), then an obtained audio is interpolated by 1/α times compared with original interpolation to obtain

$${s}_{2} ( t ) = interpolation ( {s}_{1} ( t ) , \frac{1}{α} ) .$$

A fundamental frequency curve modification parameter α is randomly sampled from a uniform distribution U(0.7, 1.3), and when the fundamental frequency curve modification parameter is greater than 1, an original fundamental frequency curve is stretched, or when the fundamental frequency curve modification parameter is less than 1, an original fundamental frequency curve is compressed. In a specific operation method, firstly a fundamental frequency curve ƒ₀=world.harvest(s(t)) and an average fundamental frequency ƒ̅₀ of the speech are extracted based on a world vocoder. Then, a fundamental frequency curve ƒ₀′=α(ƒ₀−ƒ̅₀)+ƒ̅₀ of the audio is modified. Next, a periodic parameter sp=world.cheaptrick(s(t), ƒ₀′) and an aperiodic parameter ap=world.d4c(s(t), ƒ₀′) of the audio are calculated based on the world vocoder. Finally, a modified speech s₃(t)=world.synthesize(ƒ₀′, sp, ap) is synthesized based on the world vocoder.

An energy modification parameter α is randomly sampled from a uniform distribution U(0.5, 2). An obtained modified speech is s₄(t)=αs(t).

During the time modification, the speech is directly inverted in the time domain.

In step S5, phoneme segmentation is performed.

The augmented speech data is segmented into individual vowels and consonants by using an acoustic model of a corresponding speaker based on a Prosodylab-Aligner algorithm to form a vowel set and a consonant set.

In step S6, an interference noise is generated.

The speech interference noise is continuously generated based on a noise generation algorithm. As shown in FIG. 2, a specific process includes:
randomly selecting vowels from the obtained vowel data set, splicing the vowels, performing smoothing on splicing positions by using a Hamming window with a length of 25 ms, and accelerating an obtained sequence to 1.1 times an original sequence, to obtain a first noise signal; then, randomly selecting vowels from the vowel data set, modifying a speed of each of the vowels to α times that of an original vowel, a being a random number randomly sampled from a uniform distribution U(0.3, 1.8), resampling each vowel, splicing the vowels with modified speeds, and inserting a blank space, with a length randomly sampled from a uniform distribution U(0.001, 0.1), between the vowels, to obtain a second noise signal; next, randomly selecting consonants from the consonant data set, splicing the consonants, and performing smoothing on splicing positions by using the Hamming window with the length of 25 ms, to obtain a third noise signal; and finally, directly superimposing the three noise signals, to obtain the final interference noise.

In step S7, the noise is sent.

There are multiple ways to send the noise, for example, the interference noise can be sent using an ordinary loudspeaker or based on ultrasonic transmission without affecting the speaker in an environment. The user can make a choice as needed.

To verify the effects of the present invention, experiments are conducted on the above method for designing an interference noise of speech based on the human speech structure.

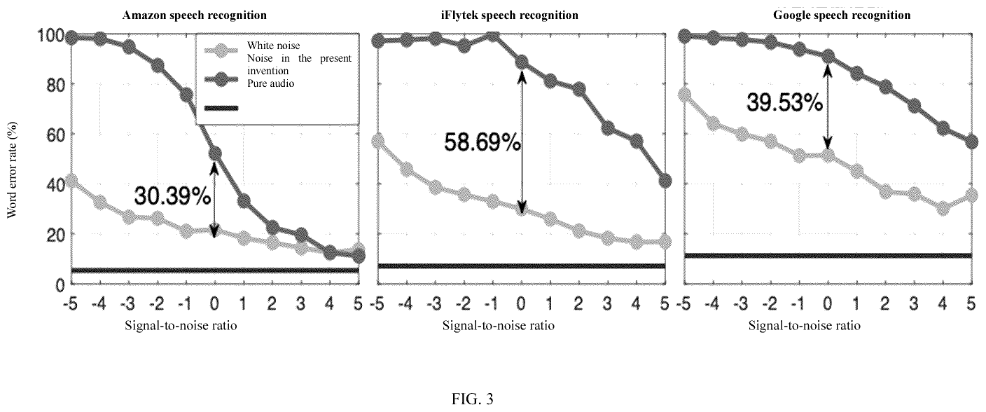

In a first experiment, the interference effects of the designed interference noise at different signal-to-noise ratios are simultaneously compared with conventional white noise interference for verification. The interfering noise is mixed with the original speech at different energy ratios (signal-to-noise ratios are between −5 and 5), then the noisy speech data is recognized in speech recognition models, and word error rates (WER, a prediction that measures a difference between a recognition result and a real text, where the larger the value is, the greater the difference is) of recognition results and the real text are calculated. The three speech recognition models (Amazon speech recognition, iFlytek speech recognition, and Google speech recognition) are tested in this experiment, and results are as shown in FIG. 3. In the three models, except for one case (Amazon speech recognition is used when a signal-to-noise ratio is 5), the interference effect of the noise designed by the present invention on the speech is better than all existing white noise interference methods.

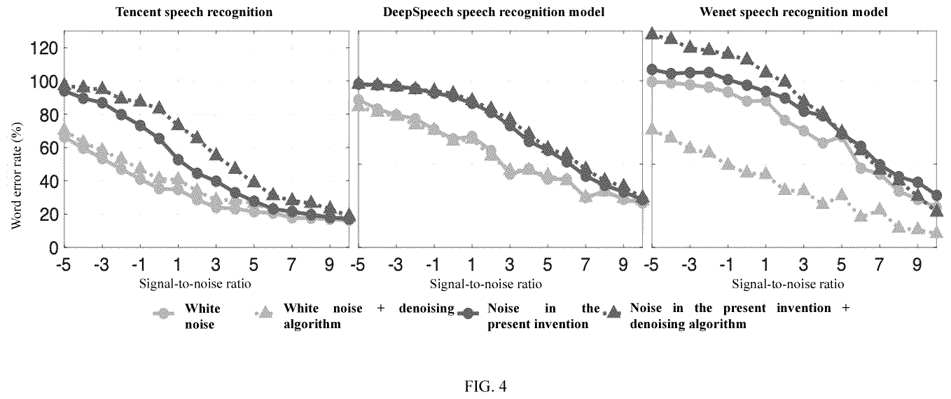

In a second experiment, the robustness of the designed interference noise to the existing denoising algorithms is simultaneously compared with the robustness of conventional white noise interference for verification. The interfering noise is mixed with the original speech at different energy ratios (signal-to-noise ratios are between −5 and 5), then the noisy speech is processed with the existing denoising algorithms, and finally audios before and after processing are input to three speech recognition models for recognition and recognition results before and after noise removal are compared. The three speech recognition models (Tencent speech recognition, DeepSpeech speech recognition, and Wenet speech recognition) are tested in this experiment, and results are as shown in FIG. 4. In the three models, compared with the existing white noise interference, the interference noise designed by the present invention exhibits stronger robustness, and the recognition accuracy of the disturbed speech after being processed with a speech denoising algorithm will not be improved.

The embodiment mentioned above provides a detailed description of the technical solution and beneficial effects of the present invention. It should be understood that the above is only the specific embodiment of the present invention and is not intended to limit the present invention. Any modifications, supplements, and equivalent substitutions made within the scope of principle of the present invention should be included within the scope of protection of the present invention.

1. A method for designing an interference noise of speech based on the human speech structure, comprising the following steps:
(1): obtaining a large amount of speech data containing different speakers and different speech contents, extracting voiceprint information of each of the speakers in the speech data, and building an initial speech data set;
(2): for each user, obtaining a small amount of speech data of the user, extracting voiceprint information of the speech data of the user, and based on the extracted voiceprint information of the user, matching the most similar speech data in the initial speech data set generated in the step (1) with a voiceprint information matching algorithm;
(3): performing data augmentation on the matched speech data in the step (2);
(4): performing phoneme-level segmentation on the augmented speech data by using a phoneme segmentation algorithm to form a vowel data set and a consonant data set;
(5): constructing three noise sequences based on the vowel data set and the consonant data set, and superimposing the three noise sequences to obtain an interference noise, wherein two noise sequences are of splicing vowel data, and one noise sequence is of splicing consonant data; and
(6): continuously generating and playing a randomly generated interference noise, and continuously injecting the interference noise into recordings to achieve continuous interference, thereby preventing the recording from being eavesdropped.

2. The method for designing an interference noise of speech based on the human speech structure according to claim 1, wherein in the steps (1) and (2), the voiceprint information is extracted with a neural network, an input of the neural network is a continuous time domain speech signal, and an output thereof is a vector representing the voiceprint information; wherein the neural network is represented by e=ƒ(x), x being a speech signal with a length of greater than 1.6 seconds, e being output voiceprint information, a dimension being 1×256.

3. The method for designing an interference noise of speech based on the human speech structure according to claim 1, wherein in the step (2), the voiceprint information matching algorithm is a cosine distance-based matching algorithm, specifically,
if it is assumed that the voiceprint information of a current user is eₜ and the voiceprint information of each of the speakers in the initial speech data set is eᵢ in which i∈[1, N] and N is the number of speakers in the initial speech data set, a matched most similar speaker j in the data set needs to satisfy the following expression:
$$d ( {e}_{t} , {e}_{j} ) \leq d ( {e}_{t} , {e}_{i} ) , ∀ i ∈ [ 1 , N ]$$
wherein d(x, y) is a cosine distance between two vectors,
$$d ( x , y ) = \frac{x \cdot y}{‖ x ‖ ‖ y ‖} .$$

4. The method for designing an interference noise of speech based on the human speech structure according to claim 1, wherein in the step (2), a length of the obtained speech data of the user is 8-15 seconds.

5. The method for designing an interference noise of speech based on the human speech structure according to claim 1, wherein in the step (3), the data augmentation with an augmentation algorithm based on speech emotional characteristics comprises five augmentation modes of speech speed modification, average fundamental frequency modification, fundamental frequency curve modification, energy modification, and time order modification.

6. The method for designing an interference noise of speech based on the human speech structure according to claim 5, wherein during the speech speed modification, a speech speed modification parameter is randomly sampled from a uniform distribution U(0.3, 1.8), and when the speech speed modification parameter is greater than 1, acceleration is indicated, or when the speech speed modification parameter is less than 1, deceleration is indicated;
during the average fundamental frequency modification, an average fundamental frequency modification parameter is randomly sampled from a uniform distribution U(0.9, 1.1), and when the average fundamental frequency modification parameter is greater than 1, a fundamental frequency is increased, or when the average fundamental frequency modification parameter is less than 1, a fundamental frequency is reduced;
during the fundamental frequency curve modification, a fundamental frequency curve modification parameter is randomly sampled from a uniform distribution U(0.7, 1.3), and when the fundamental frequency curve modification parameter is greater than 1, an original fundamental frequency curve is stretched, or when the fundamental frequency curve modification parameter is less than 1, an original fundamental frequency curve is compressed;
during the energy modification, an energy modification parameter is randomly sampled from a uniform distribution U(0.5, 2), and an original audio signal s(t) is multiplied by the energy modification parameter; and
during the time order modification, a speech is directly inverted in a time domain.

7. The method for designing an interference noise of speech based on the human speech structure according to claim 1, wherein in the step (4), the phoneme segmentation algorithm is a Prosodylab-Aligner-based alignment algorithm, and a specific segmentation process comprises:
firstly training a speaker-independent acoustic model based on a Gaussian mixture model with an open-source data set; performing fine adjustment on the acoustic model based on data of each of the speakers in the initial speech data set built in the step (1), and eventually generating a special acoustic model for each speaker; during the segmentation, firstly selecting an acoustic model for a corresponding speaker, inputting an audio and a corresponding text, and outputting, by the model, types of phonemes in the audio and corresponding timestamps in sequence; and segmenting out each of the phonemes in the audio based on the timestamps, and classifying the phonemes into vowels and consonants according to the types of the phonemes, so as to form the vowel data set and the consonant data set.

8. The method for designing an interference noise of speech based on the human speech structure according to claim 1, wherein the step (5) specifically comprises:
randomly selecting vowels from the vowel data set, splicing the vowels, performing smoothing on splicing positions by using a Hamming window with a length of 25 ms, and accelerating an obtained sequence to 1.1 times an original sequence, to obtain a first noise signal;
then, randomly selecting vowels from the vowel data set, modifying a speed of each of the vowels to α times that of an original vowel, a being a random number randomly sampled from a uniform distribution U (0.3, 1.8), resampling each vowel, splicing the vowels with modified speeds, and inserting a blank space, with a length randomly sampled from a uniform distribution U(0.001, 0.1), between the vowels, to obtain a second noise signal;
next, randomly selecting consonants from the consonant data set, splicing the consonants, and performing smoothing on splicing positions by using the Hamming window with the length of 25 ms, to obtain a third noise signal; and
finally, directly superimposing the three noise signals, to obtain the final interference noise.
